(19) United States
(12) Patent Application Publication
(10) Pub. No.: US 2014/0353491 A1
(43) Pub. Date: Dec. 4, 2014

(54) CREATING AN ION-ION REACTION REGION WITHIN A LOW-PRESSURE LINEAR ION TRAP

(71) Applicant: DH Technologies Development Pte. Ltd., Singapore (SG)

(72) Inventors: James Hager, Mississauga (CA); John Lawrence Campbell, Milton (CA)

(73) Assignee: DH Technologies Development Pte,Ltd., Singapore (SG)

(21) Appl. No.: 14/369,954

(22) PCT Filed: Dec. 6, 2012
(86) PCT No.: PCT/IB2012/002616

§ 371 Date: Jun. 30, 2014

Related U.S. Application Data
(60) Provisional application No. 61/581,783, filed on Dec. 30, 2011.

(51) Int. Cl. H01J 49/10; H01J 49/36; H01J 49/42; H01J 49/00

(52) U.S. Cl. CPC H01J 49/107; H01J 49/0031; H01J 49/36; H01J 49/4215
USPC 250/282; 250/288

(57) ABSTRACT

Methods and systems for creating a region for ion-ion reactions within a mass spectrometer are described. In various aspects, the methods and systems can confine a first group of ions in a sub-volume of a multipole ion trap, and introduce a second group of oppositely-charged ions into the multipole ion trap while maintaining the first group of ions within the sub-volume. In various embodiments, the methods and systems can operated at reduced pressures.

### RELATED APPLICATION

This application claims priority to U.S. provisional application No. 61/581,783, filed Dec. 30, 2011, which is incorporated herein by reference in its entirety.

### FIELD

The invention relates to mass spectrometry, and more particularly to methods and apparatus for creating a region for ion-ion reactions within a mass spectrometer.

### INTRODUCTION

Mass spectrometry (MS) is an analytical technique for determining the elemental composition of test substances that has both quantitative and qualitative applications. For example, MS can be useful for identifying unknown compounds, determining the isotopic composition of elements in a molecule, and determining the structure of a particular compound by observing its fragmentation, as well as for quantifying the amount of a particular compound in the sample.

With specific regard to mass spectrometric analysis of proteins and peptides, various dissociation techniques such as collision induced dissociation (CID), electron capture dissociation (ECD), and electron transfer dissociation (ETD) have been examined. Whereas CID typically involves energetic collisions between the precursor ion of interest (e.g., an ionized peptide) and inert neutral gas atoms and molecules to generate product b- and y-type ions resulting from amide cleavages of the precursor ion, ECD and ETD can generate product ions through ionic interactions with oppositely reagent ions within the mass spectrometer. In ECD, for example, low-energy electrons are captured by multiply charged positive precursor ions, which may then undergo fragmentation due to the electron capture. In ETD, the electron is typically donated or lost through an ion/ion reaction of the precursor ion with a reagent ion of the opposite charge. Whereas cleavage resulting from CID can provide amino acid sequence information for peptide and protein ions, labile post-translational modifications are often lost; for both ECD and ETD, peptide and protein ion dissociation can give rise to product c- and z-type ions and preservation of post-translational modifications of the precursor peptides through extensive cleavage of the peptide backbone.

Previous attempts to promote ion-ion reactions have generally focused on upstream regions of quadrupole-based mass spectrometers due to the increased pressures in these regions, which promote collisional cooling of the ions and thus, increased interaction time between precursor and reagent ions. Previous methods are also limited by the need to generate a devoted, static region in which both positive and negative ions can interact and/or be confined to allow for the ETD reactions to result.

Accordingly, there remains a need for improved methods and systems for creating an ion-ion reaction region within a linear ion trap.

### SUMMARY

In accordance with one aspect, certain embodiments of the applicants' teachings relate to a method for performing ion-ion reactions in a mass spectrometer system. According to the method, a first group of ions can be confined in a sub-volume of a multipole ion trap. The method also comprises introducing a second group of ions into the multipole ion trap, the first and second groups of ions being of opposite polarity. While maintaining the first group of ions within said sub-volume, an exit barrier is generated at an exit end of the multipole ion trap to reflect at least a portion of the second group of ions through said sub-volume at least two times.

In accordance with one aspect, certain embodiments of the applicants' teachings relate to a method for performing ion-ion reactions in a mass spectrometer system. According to the method, a first group of ions can be introduced into a multipole ion trap comprising a quadrupole rod set extending from a first end to a second end, the quadrupole rod set having an end electrode located at each end thereof. The method also comprises applying a DC voltage to at least one auxiliary electrode disposed between the first and second ends of the quadrupole rod set and an RF voltage to one of said end electrodes to confine the first group of ions axially within a sub-volume of the multipole ion trap between at least one auxiliary electrode and one of the end electrodes. A second group of ions is introduced into the multipole ion trap, the second group of ions being of opposite polarity to the first group of ions. The first group of ions is allowed to undergo ion-ion reactions with the second group of ions to produce product ions while maintaining the first group of ions within said sub-volume. The method can further comprise applying an RF voltage to the quadrupole rod set to confine the first and second groups of ions radially within the multipole ion trap.

In accordance with an aspect of various embodiments of the applicants' teachings, the first group of ions comprises reagent anions and the second group of ions comprises precursor cations. In various embodiments, applying a DC voltage to at least one auxiliary electrode comprises applying a negative DC voltage thereto.

In accordance with an aspect of various embodiments of the applicants' teachings, the first group of ions comprises precursor cations and the second group of ions comprises reagent anions. In various embodiments, applying a DC voltage to at least one auxiliary electrode comprises applying a positive DC voltage thereto.

In accordance with an aspect of various embodiments of the applicants' teachings, the first group of ions comprises reagent cations and the second group of ions comprises precursor anions. In various embodiments, applying a DC voltage to at least one auxiliary electrode comprises applying a negative DC voltage thereto.

In accordance with an aspect of various embodiments of the applicants' teachings, the first group of ions comprises precursor anions and the second group of ions comprises reagent cations. In various embodiments, applying a DC voltage to at least one auxiliary electrode comprises applying a negative DC voltage thereto.

In accordance with an aspect of various embodiments of the applicants' teachings, allowing the first group of ions to interact with the second group of ions to produce product ions while maintaining the first group of ions within said sub-volume comprises maintaining the DC voltage on at least one auxiliary electrode disposed between the first and second ends of the quadrupole rod set and an RF voltage on one of said end electrodes. In various embodiments, the method further comprises, while maintaining the first group of ions within said sub-volume, applying a barrier voltage to the other of said end electrodes to trap the second group of ions within the multipole ion trap. In various embodiments, the barrier voltage comprises an RF voltage. In various embodiments, the barrier voltage comprises a DC voltage having the same polarity as the second group of ions. In various embodiments, the barrier voltage causes said second group of ions to make multiple passes through said sub-volume.

In accordance with an aspect of various embodiments of the applicants' teachings, the end electrodes comprise a first end electrode located adjacent to the first end of the quadrupole rod set and a second end electrode located adjacent to the second end of the quadrupole rod set. Further, at least one auxiliary electrode comprises a plurality of auxiliary electrodes interposed between the quadrupole rods and extending from a first end to a second end along a length of the quadrupole rod set, the first end of the auxiliary electrodes being located between the first end of the quadrupole rod set and the second end of the auxiliary electrodes. The second end of the auxiliary electrodes is located between the first end of the auxiliary electrodes and the second end of the quadrupole rod set. In various embodiments, applying a DC voltage to the auxiliary electrodes comprises applying a negative DC voltage such that the first group of ions are axially confined between the second end of the auxiliary electrodes and the second end electrode, the first group of ions having a negative polarity.

In various embodiments, the ion-ion reaction comprises an electron transfer dissociation reaction. In various embodiments, the ion-ion reaction comprises a proton-transfer reaction. In various embodiments, the quadrupole rod set comprises Q3 in a triple quadrupole mass spectrometer.

In accordance with an aspect of various embodiments of the applicants' teachings, the auxiliary electrodes comprise T-electrodes. In various embodiments, the T-electrodes have an increasing depth of radial penetration along a length of the quadrupole rod set.

In some aspects, the quadrupole rod set can be contained within a vacuum chamber such that a base operating pressure is less than about 1×10⁻⁴ Torr. In various aspects of various embodiments of the applicants' teachings, the method further comprises introducing one or more pulses of a gas into said sub-volume. In some aspects, pulses of gas are configured to increase the pressure in said sub-volume in a range of about 6×10⁻⁵ Torr to about 5×10⁻⁴ Torr.

In some aspects, the second group of ions are introduced into the multipole ion trap with a kinetic energy less than about 10 eV.

In accordance with an aspect of various embodiments of the applicants' teachings, there is provided a mass spectrometer system comprising one or more ion sources configured to generate a first group of ions and a second group of ions, wherein the first and second groups of ions have opposite polarities. The system can also comprise a multipole ion trap comprising (i) a quadrupole rod set extending from a first end to a second end, (ii) at least one auxiliary electrode disposed between the first and second ends of the quadrupole rod set, and (iii) end electrodes located at both ends of the quadrupole rod set. A controller, operatively coupled to the multipole ion trap, is configured to i) apply a DC voltage to at least one auxiliary electrode and an RF voltage to one of said end electrodes to confine the first group of ions axially within a sub-volume of the multipole ion trap between at least one auxiliary electrode and said one of said end electrodes, and ii) apply a barrier voltage to the other of said end electrodes while maintaining the first group of ions within said sub-volume such that the first and second group of ions are trapped within the multipole ion trap and can interact to produce product ions.

In various embodiments, the barrier voltage comprises an RF voltage. In various embodiments, the barrier voltage comprises a DC voltage having the same polarity as the second group of ions.

In accordance with an aspect of various embodiments of the applicants' teachings, the controller is configured to apply or adjust voltages to any of the quadrupole rod sets, auxiliary electrodes, or end electrodes so as to cause said second group of ions to make multiple passes through said sub-volume.

In various embodiments, the first group of ions comprises reagent anions and the second group of ions comprises precursor cations. In one aspect, the controller is configured to apply a negative DC voltage to at least one auxiliary electrode to confine the reagent anions axially within the sub-volume of the multipole ion trap between at least one auxiliary electrode and one of the end electrodes.

In various embodiments, the first group of ions comprises precursor cations and the second group of ions comprises reagent anions. The controller is configured to apply a positive DC voltage to at least one auxiliary electrode to confine the precursor cations axially within the sub-volume of the multipole ion trap between at least one auxiliary electrode and one of the end electrodes.

In accordance with an aspect of various embodiments of the applicants' teachings, the controller is further configured to apply an RF voltage to the quadrupole rod set to confine the first and second groups of ions radially within the multipole ion trap.

In one aspect of various embodiments of the applicants' teachings, the end electrodes comprise a first end electrode located adjacent to the first end of the quadrupole rod set and a second end electrode located adjacent to the second end of the quadrupole rod set. At least one auxiliary electrode comprises a plurality of auxiliary electrodes interposed between the quadrupole rods and extending from a first end to a second end along a length of the quadrupole rod set, the first end of the auxiliary electrodes being located between the first end of the quadrupole rod set and the second end of the auxiliary electrodes, and the second end of the auxiliary electrodes being located between the first end of the auxiliary electrodes and the second end of the quadrupole rod set. In various embodiments, the controller is configured to apply a negative DC voltage to the auxiliary electrodes such that the first group of ions, which can have a negative polarity, are axially confined between the second end of the auxiliary electrodes and the second end electrode.

In accord with an aspect of various embodiments of the applicants' teachings, the quadrupole rod set comprises Q3 in a triple quadrupole mass spectrometer. In some aspects, the quadrupole rod set is contained within a vacuum chamber such that a base operating pressure is less than about 1×10⁻⁴ Torr. In various aspects, the system further comprises a gas source configured to introduce one or more pulses of a gas into said sub-volume. By way of example, the pulses of gas are configured to increase the pressure in said sub-volume in a range of about 6×10⁻⁵ Torr to about 5×10⁻⁴ Torr.

In accord with an aspect of various embodiments of the applicants' teachings, the auxiliary electrodes comprise T-electrodes. In some aspects, the T-electrodes can have an increasing depth of radial penetration along a length of the quadrupole rod set.

These and other features of the applicants' teaching are set forth herein.

### BRIEF DESCRIPTION OF THE DRAWINGS

A detailed description of various embodiments is provided herein below with reference, by way of example, to the following drawings. It will be understood that the drawings are exemplary only and that all reference to the drawings is made for the purpose of illustration only, and is not intended to limit the scope of the embodiments described herein below in any way. For convenience, reference numerals may also be repeated (with or without an offset) throughout the figures to indicate analogous components or features.

FIG. 1, in a schematic diagram, illustrates a QTRAP® Q-q-Q hybrid linear ion trap mass spectrometer system comprising auxiliary electrodes in accordance with one aspect of various embodiments of the applicants' teachings.

FIG. 2, in schematic diagram, depicts in detail the Q3 quadrupole in the mass spectrometer system shown in FIG. 1.

FIG. 3A, in schematic diagram, illustrates an axial view of the set of quadrupole rods and auxiliary electrodes taken along the dashed line shown in FIG. 2.

FIG. 3B, in schematic diagram, illustrates an axial view of the set of quadrupole rods and auxiliary electrodes taken along the dashed line shown in FIG. 2.

FIG. 4, in a schematic diagram, illustrates a mass spectrometer system and corresponding potentials along the central axis at various steps of a method for performing ion-ion reactions in accordance with one aspect of various embodiments of the applicants' teachings.

FIG. 5 schematically depicts a quadrupole linear ion trap and apparatus to inject a gas into the trap in accordance with one aspect of various embodiments of the applicants' teachings.

FIG. 6 schematically depicts a quadrupole linear ion trap comprising auxiliary electrodes and a collar electrode in accordance with one aspect of various embodiments of the applicants' teachings.

FIG. 7 depicts experimental mass spectral data obtained using various systems and methods for providing ion-ion reactions within a hybrid linear ion trap mass spectrometer, some in accordance with aspects of various embodiments of the applicants' teachings.

### DETAILED DESCRIPTION OF VARIOUS EMBODIMENTS

It will be appreciated that for clarity, the following discussion will explicate various aspects of embodiments of the applicants' teachings, but omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicants' teachings may not require certain of the specifically described details in every implementation, which are set forth herein only to provide a thorough understanding of the embodiments. Similarly it will be apparent that the described embodiments may be susceptible to slight alteration or variation according to common general knowledge without departing from the scope of the disclosure. The following detailed description of embodiments is not to be regarded as limiting the scope of the applicants' teachings in any manner.

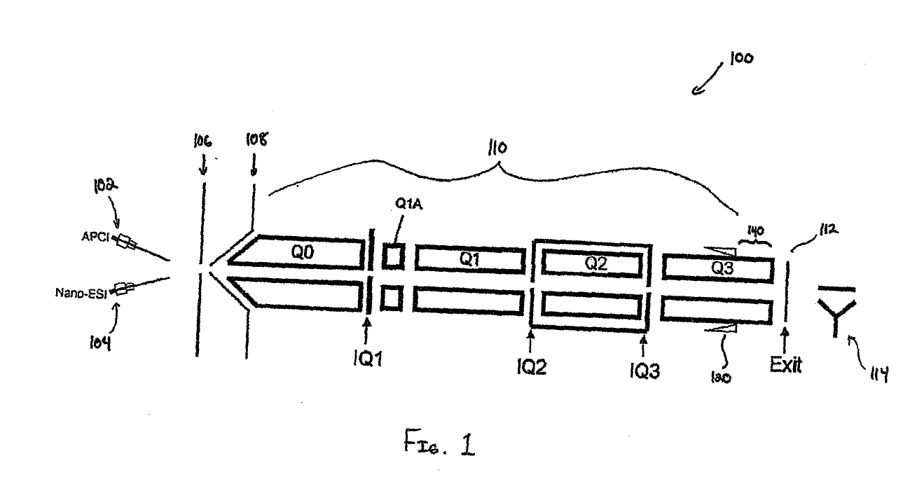

While the systems, devices, and methods described herein can be used in conjunction with many different mass spectrometer systems, an exemplary mass spectrometer system 100 for such use is illustrated schematically in FIG. 1. It should be understood that the mass spectrometer system 100 represents only one possible mass spectrometer instrument for use in accordance with embodiments of the systems, devices, and methods described herein, and mass spectrometers having other configurations can all be used in accordance with the systems, devices and methods described herein as well.

In the exemplary embodiment depicted in FIG. 1, the mass spectrometer system comprises a QTRAP® Q-q-Q hybrid linear ion trap mass spectrometer 100, as generally described by Hager and LeBlanc in Rapid Communications of Mass Spectrometry 2003, 17, 1056-1064 and modified in accord with the teachings herein. The mass spectrometer system 100 can comprise one or more ion sources 102,104, a detector 114, and a mass analyzer 110 located therebetween. As shown in FIG. 1, the mass analyzer 110 can comprise four elongated sets of rods: Q0, Q1, Q2, and Q3, with orifice plates IQ1 after rod set Q0, IQ2 between Q1 and Q2, and IQ3 between Q2 and Q3. For convenience, the elongated rod sets Q0, Q1, Q2, and Q3 are generally referred to herein as quadrupoles (that is, they have four rods), though the elongated rod sets can be any other suitable multipole configurations, for example, hexapoles, octapoles, etc. Q0, Q1, Q2, and Q3 can be disposed in adjacent chambers that are separated, for example, by aperture lenses IQ1, IQ2, and IQ3, and are evacuated to sub-atmospheric pressures as is known in the art. By way of example, a mechanical pump (e.g., a turbo-molecular pump) can be used to evacuate the vacuum chambers to appropriate pressures. An exit lens 112 can be positioned between Q3 and the detector 114 to control ion flow into the detector 114. The quadrupoles Q1, Q2, and Q3 can be coupled with a power supply (not shown) to receive RF and/or DC voltages chosen to configure the quadrupole rod sets for various different modes of operation depending on the particular MS application. As will be appreciated by a person skilled in the art, ions can be trapped radially in any of Q0, Q1, Q2, and Q3 by RF voltages applied to the rod sets, and axially through the application of RF and/or DC voltages applied to various components of the mass spectrometer system 100, as discussed in detail below.

Because ion-ion reactions require ions of opposite polarities, one or more ion sources 102, 104 can be provided to generate the ions. As shown in FIG. 1, for example, an atmospheric pressure chemical ionization (APCI) source 102 can be used to generate reagent anions while an electrospray ionization (ESI) source 104 can be used to generate precursor cations. Though the system 100 is shown with respect to separate ion sources 102, 104, one of skill in the art will appreciate that a single ion source that can operate in both positive and negative ion modes can also be used to generate the ions. Though a dual ESI-APCI ion source 102, 104 is depicted as generating and injecting the analyte cations and reagent anions, the ion sources can be any suitable ion source modified in light of the teachings herein. By way of non-limiting example, the ion source(s) 102, 104 can be a continuous ion source, a pulsed ion source, an inductively coupled plasma (ICP) ion source, a matrix-assisted laser desorption/ionization (MALDI) ion source, a glow discharge ion source, an electron ionization ion source, a chemical ionization source, or a photoionization ion source, among others.

During operation of the mass spectrometer 100, ions generated by the ion sources 102, 104 can be extracted into a coherent ion beam by passing successively through apertures in an orifice plate 106 and a skimmer 108 to result in a narrow and highly focused ion beam. In various embodiments, an intermediate pressure chamber can be located between the orifice plate 106 and the skimmer 108 that can be evacuated to a pressure approximately in the range of about 1 Torr to about 4 Torr, though other pressures can be used for this or for other purposes. In some embodiments, upon passing through the skimmer 108, the ions can traverse one or more additional vacuum chambers and/or quadrupoles (e.g., a QJet® quadrupole) to provide additional focusing of and finer control over the ion beam using a combination of gas dynamics and radio frequency fields.

Ions generated by the ion source(s) 102, 104 can then enter the quadrupole rod set Q0, which can be operated as a collision focusing ion guide, for instance by collisionally cooling ions located therein. Q0 can be situated in a vacuum chamber and can be associated with a mechanical pump operable to evacuate the chamber to a pressure suitable to provide collisional cooling. For example, the vacuum chamber can be evacuated to a pressure approximately in the range of about 3 milliTorr to about 10 milliTorr, though other pressures can be used for this or for other purposes. Quadrupole rod set Q0 can be excited in RF-only mode to operate in conjunction with the pressure of vacuum chamber as a collimating quadrupole. A lens IQ1 can be disposed between the vacuum chamber of Q0 and the adjacent chamber to isolate the two chambers.

After passing through Q0, the ions can enter the adjacent quadrupole rod set Q1, which can be situated in a vacuum chamber that can be evacuated to a pressure approximately in the range of about 40 milliTorr to about 80 milliTorr, though other pressures can be used for this or for other purposes. As will be appreciated by a person of skill in the art, the quadrupole rod set Q1 can be operated as a conventional transmission RF/DC quadrupole mass filter that can be operated to select an ion of interest and/or a range of ions of interest. By way of example, the quadrupole rod set Q1 can be provided with RF/DC voltages suitable for operation in a mass-resolving mode. As should be appreciated, taking the physical and electrical properties of Q1 into account, parameters for an applied RF and DC voltage can be selected so that Q1 establishes a transmission window of chosen m/z ratios, such that these ions can traverse Q1 largely unperturbed. Ions having m/z ratios falling outside the window, however, do not attain stable trajectories within the quadrupole and are prevented from traversing the quadrupole rod set Q1. It should be appreciated that this mode of operation is but one possible mode of operation for Q1. By way of example, the lens IQ2 between Q1 and Q2 can be maintained at a much higher offset potential than Q1 such that ions entering the quadrupole rod set Q1 be operated as an ion trap. In such a manner, the potential applied to the entry lens IQ2 can be selectively lowered (e.g., mass selectively scanned) such that ions trapped in Q1 can be accelerated into Q2, which could also be operated as an ion trap, for example.

In some embodiments, a set of stubby rods can be provided between neighboring pairs of quadrupole rod sets to facilitate the transfer of ions between quadrupoles. The stubby rods can serve as a Brubaker lens and can help minimize interactions with any fringing fields that may have formed in the vicinity of an adjacent lens, for example, if the lens is maintained at an offset potential. By way of non-limiting example, FIG. 1 depicts stubby rods Q1A between IQ1 and the rod set Q1 to focus the flow of ions into Q1. Stubby rods can also be included upstream and downstream of the elongated rod set Q2, for example.

Ions passing through the quadrupole rod set Q1 can pass through the lens IQ2 and into the adjacent quadrupole rod set Q2, which as shown can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to thermalize and/or fragment ions in the ion beam. In some embodiments, application of suitable RF/DC voltages to the quadrupole rod set Q2 and entrance and exit lenses IQ2 and IQ3 can provide optional mass filtering.

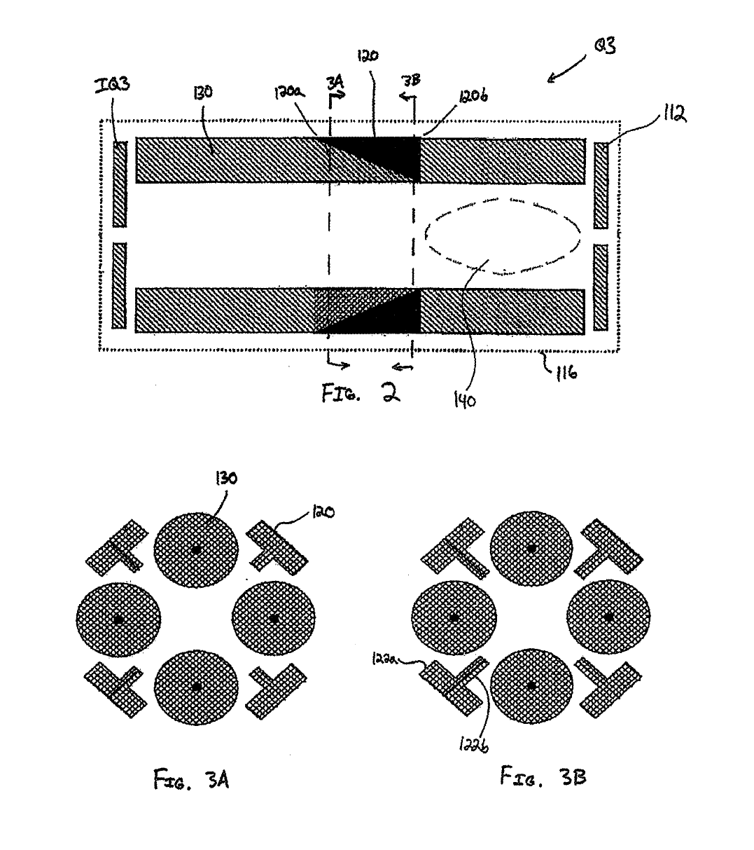

Ions that are transmitted by Q2 can pass into the adjacent quadrupole rod set Q3, which is bounded upstream by IQ3 and downstream by the exit lens 112. The quadrupole rod set Q3 can be situated in a vacuum chamber (e.g., 116 in FIG. 2) and can be associated with a pump operable to evacuate the chamber to a decreased operating pressure relative to that of Q2, for example, less than about 1×10⁻⁴ Torr, though other pressures can be used for this or for other purposes. As will be appreciated by a person skilled in the art, Q3 can be operated in a number of manners, for example as a scanning RF/DC quadrupole or as a linear ion trap. As shown in FIG. 1, Q3 can comprise auxiliary electrodes 120 such that Q3 can be utilized as an ion-ion reaction region in accord with an aspect of various embodiments of the applicants' teachings. In accordance with an aspect of various embodiments of the applicants' teachings, auxiliary electrodes 120 can be used within Q3 to create hexapole and octapole RF fields and/or electrostatic fields in addition to the main RF quadrupole field provided by the quadrupole electrodes. As will be discussed in detail below, the auxiliary electrodes 120 can be effective to define a sub-volume 140 in Q3 in which ions of one polarity can be trapped and through which ions of the opposite polarity can be passed one or more times via the application of various potentials to Q3, the auxiliary electrodes 120, IQ3, and the exit lens 112, as will be discussed in detail below.

Following the reaction between the precursor ions and reagent ions of opposite polarity in the sub-volume 140 in Q3, residual precursor ions and product ions can be transmitted into the detector 114 through the exit lens 112. The detector 114 can then be operated in a manner known to those skilled in the art in view of the systems, devices, and methods described herein. As will be appreciated by a person skill in the art, any known detector, modified in accord with the teachings herein, can be used to detect the ions.

Referring now to FIG. 2, an exemplary embodiment of Q3 operating as an ion-ion reaction region is depicted in more detail. As shown in FIG. 2, Q3 can be bounded by end-cap electrodes and can comprise four rod-like electrodes 130, which run substantially parallel to the ion path, and four auxiliary electrodes 120 interposed therebetween. By way of example, the lens IQ3 positioned between Q2 and Q3 can serve as the upstream end-cap electrode while the exit lens 112 can serve as the downstream end-cap electrode.

As shown in FIG. 2, the auxiliary electrodes 120 can be axially positioned relative to the rod-like electrodes 130 so as to define a sub-volume 140 within Q3 in which ions of a first polarity can be trapped through the application of appropriate potentials to the rod-like electrodes 130, the auxiliary electrodes 120, and the exit lens 112. In the depicted embodiment, for example, the auxiliary electrodes 120 extend from a first end to a second end and are axially positioned in an intermediate region of Q3. For example, the first end 120a of the auxiliary electrodes 120 can be positioned downstream from the upstream end of Q3 while the second end 120b of the auxiliary electrodes can be positioned upstream from the downstream end of Q3. As will be discussed in detail below, by having the second end 120b of the auxiliary electrodes spaced a distance apart from the downstream end of Q3, a sub-volume 140 can be defined within Q3 generally between the second end 120b of the auxiliary electrodes 120 and the downstream end of Q3. The auxiliary electrodes 120 can have various lengths, for example in some embodiments, the auxiliary electrodes can extend over less than half the length of Q3.

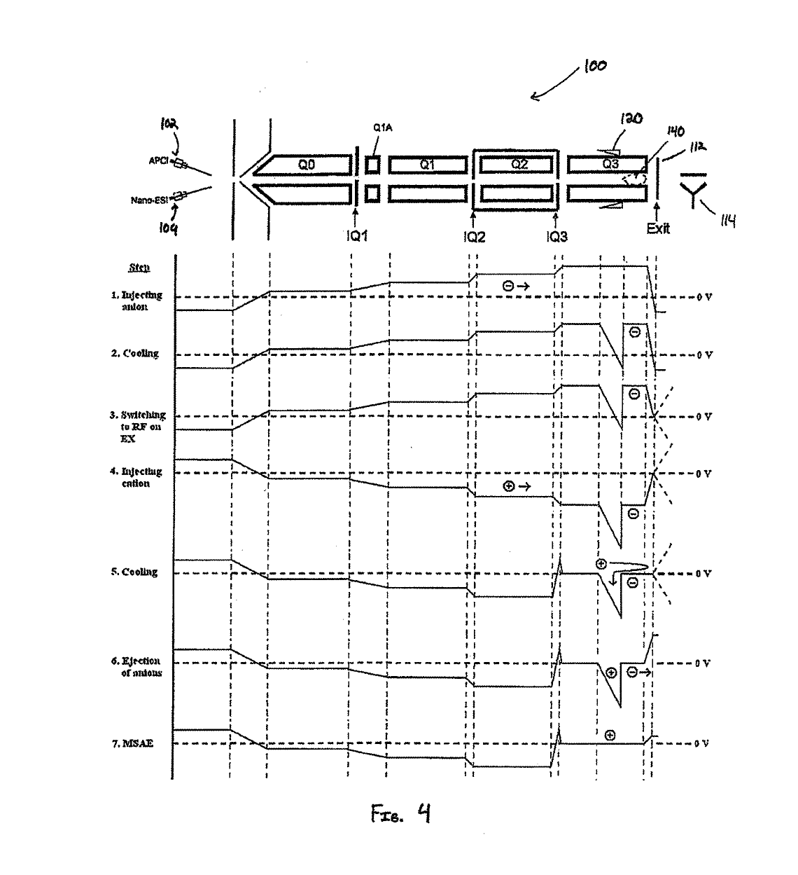

With reference now to FIGS. 3A and 3B, cross-sections of Q3 along the dotted lines of FIG. 2 are shown to depict the radial position of the auxiliary electrodes 120 relative to the rod-like electrodes 130 of Q3. The auxiliary electrodes 120 can be powered by an auxiliary voltage power supply that can provide an RF and/or DC voltage to the auxiliary electrodes. As shown, the auxiliary electrodes 120 can be T-electrodes having a rectangular base section 122a spaced from the central axis of Q3, and a rectangular stem 122b that extends toward the central axis of Q3 from the rectangular base section. As will be appreciated by a person skilled in the art, the T-shaped electrodes can be tapered (linearly or non-linearly) in the longitudinal direction such that an axial field can be generated within Q3 along the length of the auxiliary electrodes 120 by applying an auxiliary DC potential (with or without an auxiliary RF potential) to the auxiliary electrodes 120. By way of example, the radial penetration depth of the stem 122b of each auxiliary electrode 120 can increase from the first end of the auxiliary electrodes (as shown in FIG. 3A) to the second end of the auxiliary electrode (as shown in FIG. 3B). As will be appreciated by a person skilled in the art, the axial field can diminish quickly downstream of the second end of the auxiliary electrodes such that the DC field at the second end 120b of the auxiliary electrodes 120 can act as a blocking barrier to confine ions of a certain polarity within the sub-volume 140.

As will be apparent to those of skill in the art, other auxiliary electrode configurations can also be used to generate an axial field along a portion of the length of Q3. By way of example, a series of ring electrodes disposed outside of the rod-like electrodes can be used to generate an axial field that terminates prior to the downstream end of Q3. Alternatively, for example, tilted or conical rods (e.g., LINAC electrodes) disposed between the rod-like electrodes can be used to generate an axial field that terminates prior to the downstream end of Q3.

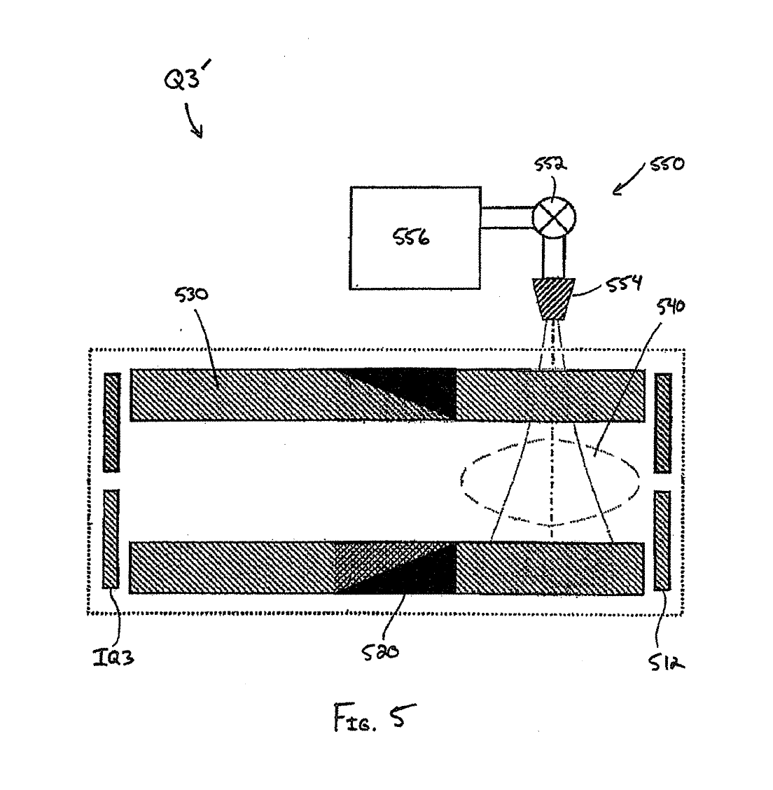

Referring now to FIG. 4, a schematic of the mass spectrometer system 100 and the corresponding potentials along the central axis at various steps of a method for performing ion-ion reactions in the Q3 quadrupole is shown. The horizontal axis represents distance along the instrument axis (not drawn to scale) with the vertical dashed lines aligning with the corresponding elements of the mass spectrometer system 100. The curves are intended to illustrate by way of non-limiting example relative voltages along the axis of the mass spectrometer, wherein the dashed horizontal axes represent 0 V. The first step of an exemplary sequence in accord with the teachings herein is shown at the top and the subsequent steps below.

As shown in step 1, reagent anions can be generated by an ion source (e.g., APCI 102) and driven through Q0, Q1, Q2, and Q3 by way of an increasing positive voltage between subsequent quadrupoles. For example, the positive DC voltage applied to Q2 can be greater than the positive DC voltage applied to Q1. As will be appreciated by those of ordinary skill in the art, the electric potential between adjacent quadrupoles, and in light of the pressures therein, can be adjusted to control the reagent anions' energy as they traverse downstream through the mass spectrometer system. Additionally, each quadrupole can be configured to perform other functions as the ions traverse therethrough. By way of example, Q1 can be operated in an RF/DC mass filter mode to preferentially transmit the reagent ion of interest into Q2. An RF or negative DC potential can be applied to the exit lens 112 to prevent axial transmission of the reagent anions into the detector 114. As will be appreciated by a person skilled in the art, the reagent anions can traverse the mass spectrometer as a continuous beam or a pulse of ions.

As shown in step 2, as the ions traverse Q3 towards the exit lens 112, a negative DC voltage can be applied to the auxiliary electrodes 120, thereby generating an axial field along a portion of the length of Q3. As depicted, the axial field can terminate at the downstream end of the auxiliary electrodes 112, thereby creating a negative DC potential barrier effective to repulse the reagent anions. Accordingly, reagent anions can be trapped in a sub-volume 140 of Q3 between the downstream end of the auxiliary electrodes 120 and the exit lens 112. After the reagent anions trapped in the sub-volume 140 have sufficiently cooled, the negative DC voltage applied to the exit lens 112 can be replaced by an RF voltage that can continue to repel the reagent anions from the exit lens 112, as depicted in step 3.

As shown in step 4, precursor cations can then be generated by an ion source (e.g., ESI 104). The precursor cations can be driven through Q0, Q1, Q2, and Q3 by way of a negative voltage increasing in amplitude between subsequent quadrupoles. For example, the negative DC voltage applied to Q2 can be greater in amplitude than the negative DC voltage applied to Q1. As above, Q1, for example, can also operate in RF/DC mode to preferentially transmit the precursor cations. As will be appreciated by those of ordinary skill in the art, the electric potential between adjacent quadrupoles, in light of the pressures therein, can be adjusted to control the cations' energies as they traverse the mass spectrometer system 100 and enter Q3. For example, the energy of the cations as they enter the trap can be less than about 10 eV.

As shown in step 5, after the precursor cations enter Q3, the IQ3 voltage can be replaced by a positive DC voltage and/or an RF voltage to trap the precursor cations within Q3 and allow for their thermalization. As the precursor cations initially traverse Q3, the RF voltage applied to the exit lens 112 can be effective to repulse the precursor cations back towards IQ3 while the reagent anions remain trapped in the sub-volume 140. Because of the reduced pressure in Q3 relative to that typical in Q2, the thermalization period of the precursor cations can be relatively long. As a result, the precursor cations can be repulsed one or more times by the RF barrier exit lens 112 and the RF/DC barrier IQ3, thereby allowing for multiple interactions between the precursor cations and reagent anions as the precursor cations pass through the sub-volume 140. After cooling and/or reacting with the reagent anions, residual precursor cations and positively-charged product ions can settle in the negative potential well generated by the auxiliary electrodes 120.

In various embodiments, the reagent anions can then be ejected from Q3, for example, by replacing the RF voltage applied to the exit lens 112 with a positive DC voltage, as shown in step 6. In step 7, the DC voltage applied to the auxiliary electrodes 120 can then be turned off and the residual precursor cations and/or positively-charged product cations can then be ejected out of Q3 through the exit lens 112 and into the detector 114. For example, the residual precursor and/or product ions can be subjected to mass selective axial ejection (MSAE) to allow for their detection, as is described in more detail in U.S. Pat. No. 6,177,668, which is hereby incorporated by reference in its entirety.

Though the illustrated sequence depicts potentials for the trapping of reagent anions in a sub-volume 140 of Q3 and the subsequent passage therethrough and trapping of precursor cations in Q3, one of skill in the art will appreciate that the timing and potential schematic depicted in FIG. 4 can likewise be modified such that the precursor cations can first be trapped in a sub-volume of Q3 with the reagent anions subsequently passed therethrough. Moreover, systems and methods in accord with applicant's teachings can be used to promote ion-ion reactions between negatively charged precursor ions that can be dissociated by positively charged reagent ions. By way of example, reagent cations can be trapped in a sub-volume of Q3 and the precursor anions can be passed therethrough. Alternatively, precursor anions can be trapped in a sub-volume of Q3 with the reagent cations subsequently passed therethrough.

With reference now to FIG. 5, in various embodiments, Q3′ can additionally comprise a gas source 550 to generate a gas flow within at least a portion of the ion-confinement region of Q3′. The delivery of a neutral gas to the ion-confinement region to produce a pressure increase within the quadrupole Q3′ can be achieved in a variety of different ways. The gas source 530 can be located at various positions and orientations relative to Q3′. For example, in various embodiments, neutral gas can be delivered to the sub-volume 540 of Q3′ with a pulsed valve 552 having a gas-injection nozzle 554 used to deliver the neutral gas from a gas supply 556. Though FIG. 5 depicts a nozzle 554 that can deliver a plume of neutral gas substantially perpendicular to the ion path, it should be appreciated that the gas source 550 can be designed to deliver a plume at a non-perpendicular angle relative to the ion path. By way of example, the nozzle 554 can be angled about 45° to deliver a plume towards the middle of Q3′ and away from the exit lens 512.

Accordingly, in various embodiments, pulses of the neutral gas can temporarily raise the base operating pressure in Q3′ to a pressure in a range of about 6×10⁻⁵ Torr to about 5×10⁻⁴ Torr during periods of interaction between the ions substantially confined within the sub-volume 540 and those ions of opposite polarity that pass therethrough. By way of example, collisional dampening of the cations' axial movement towards the exit lens 512 can aid in axially confining the cations within Q3′. Without being bound by any particular theory, the neutral gas can thermalize the cations passing through the sub-volume 540 and/or ensure mixing of the various populations of ions. Other details regarding the use of a pulsed valve can be found in U.S. Ser. No. 12/359,526, entitled “Method of Operating a Linear Ion Trap to Provide Low Pressure Short Time High Amplitude Excitation with Pulsed Pressure” and filed Jan. 26, 2009 which is hereby incorporated by reference in its entirety, and modified in accord with the teachings herein.

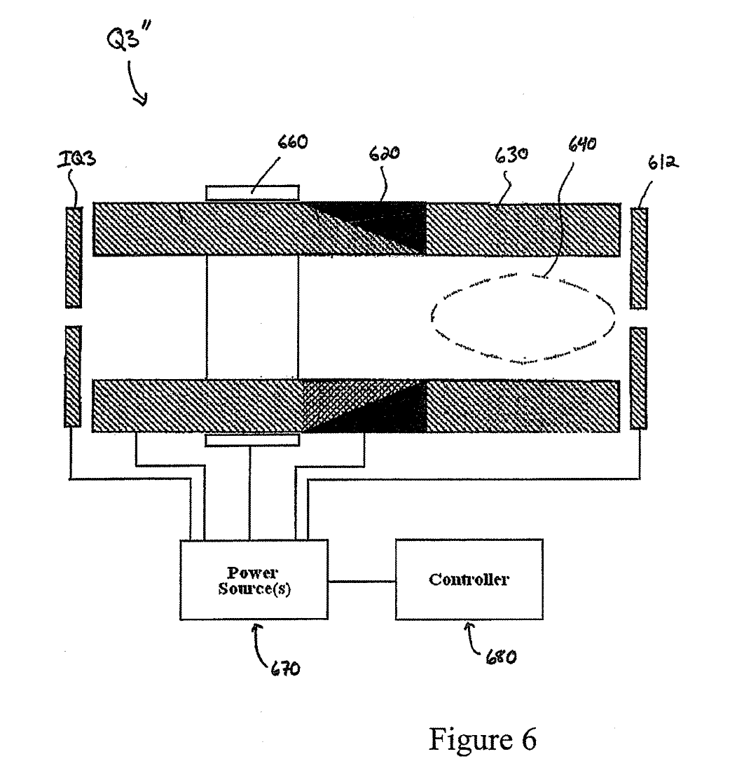

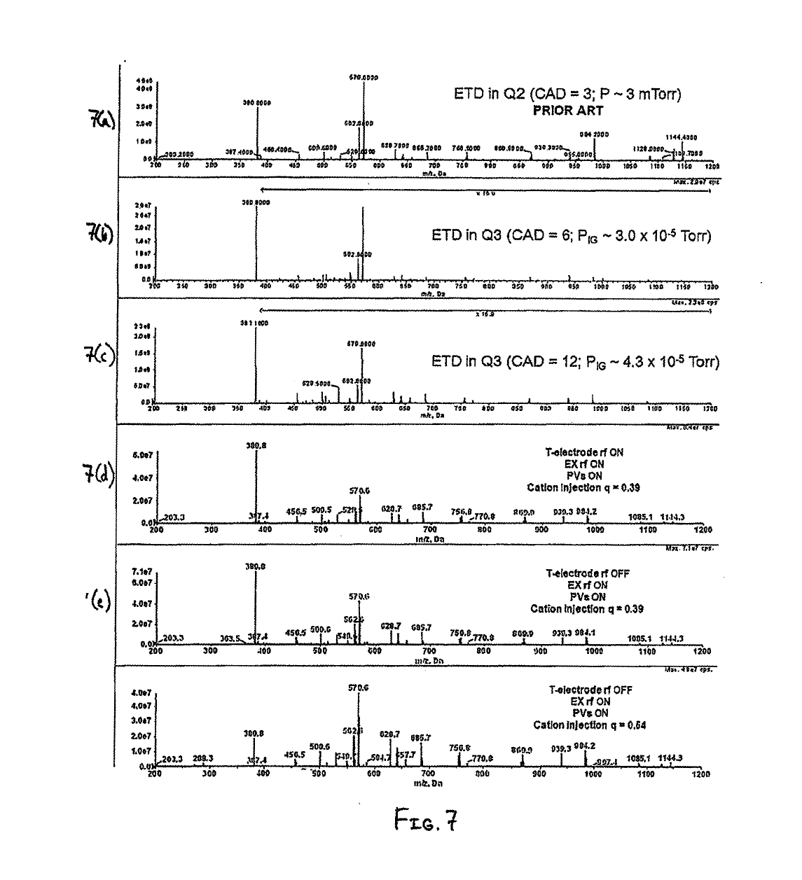

With reference now to FIG. 6, in various embodiments, Q3″ can additionally comprise a collar electrode 660, or other auxiliary electrodes, which, when a suitable potential is applied, can be used to generate additional varying or electrostatic potentials along a portion of the length of Q3″. By way of example, the collar electrode 660 can be disposed around the rod-like electrodes 630 at a position upstream from the auxiliary electrodes 620. In performing the method generally described above with reference to FIG. 4, the use of the collar electrode 660 can be used to control the precursor cations' axial movement. By way of example, a positive DC voltage applied to the collar electrode can be effective to slow a cation that has been repulsed by the exit lens 612 and is traversing Q3″ towards IQ3.

As will be appreciated by a person skilled in the art, one or more power supplies controlled by a controller can be effective to apply electric potentials with RF, AC, and DC components to the quadrupole rods, the various lenses, and auxiliary electrodes to control the radial and axial movement of the ions as otherwise discussed herein. The controller can be linked to the various components in order to provide joint control over the timing sequences executed by these elements. Accordingly, the controller can be configured to provide control signals to the power source(s) supplying the various components in a coordinated fashion in order to control the mass spectrometer system to provide for ion-ion reactions as otherwise discussed herein.

By way of example, as shown in FIG. 6, a power source 670, controlled by controller 680, can apply an RF signal to the rod-like electrodes 630 to generate an RF quadrupolar confinement field to confine the ions radially within Q3″. Likewise, the controller 680 can provide a suitable RF barrier and/or DC barrier at an exit lens 612. In such a way, the controller can control the application of voltages to the components of various embodiments of the mass spectrometer systems to provide for ion-ion reactions in accord with the teachings herein.

FIG. 7 depicts experimental mass spectral data obtained using various techniques for providing ion-ion reactions within a triple quadrupole mass spectrometer. With specific reference to FIG. 7(a), mass spectral data is presented for a prior art method for providing ion-ion reactions in the relatively high pressure region of Q2 (e.g., about 3 mTorr) of a triple quadrupole spectrometer. The method entails simultaneously axially confining ions of opposite polarity in Q2 through the application of RF barrier voltages to IQ2 and IQ3.

With reference now to FIGS. 7(b) and 7(c), the prior art mutual storage of precursor and reagent ions in Q2 that was used to generate the mass spectra of FIG. 7(a) was applied to Q3. FIG. 7(b) depicts the mass spectral data for the mutual storage technique at a pressure of about 3×10⁻⁵ Torr in Q3. FIG. 7(c) depicts the mass spectral data for the mutual storage technique at a pressure of about 4.5×10⁻⁵ Torr in Q3. As shown in FIGS. 7(b) and 7(c), however, the application of mutual storage techniques in Q3 failed to generate a strong product ion signal. It should be appreciated, for example, the signal for product ions having an m/z of greater than about 600 in FIG. 7(a) is substantially reduced in the mass spectra of FIGS. 7(b) and 7(c). While not being bound by any particular theory, it is believed that the collisional cooling provided by the elevated pressure in Q2 increases residence and/or interaction time between the oppositely charged ions relative to Q3.

FIG. 7(d) depicts experimental mass spectral data obtained using a method for performing ion-ion reactions in Q3 in accord with aspects of various embodiments of the applicants' teachings. In this non-limiting example, reagent anions were first injected into a Q3 as generally configured as shown in FIG. 5 (with the addition of collar electrode 660 of FIG. 6) and operating at a standard Q3 pressure (e.g., about 3×10⁻⁵ Torr). As discussed otherwise herein, the reagent anions were initially trapped in a sub-volume of Q3 adjacent to the downstream end of the quadrupole rod set through the application of various trapping potentials to the exit lens 512, auxiliary electrodes 520, and quadrupole rods 530. These potentials comprised, for example, a negative DC potential applied to the exit lens 512, an RF voltage and negative DC voltage applied to the auxiliary electrodes 520, and an RF voltage applied to the quadrupole rods 530. After the reagent anions were trapped and cooled within the sub-volume 540, precursor cations generated by the source were subsequently injected into Q3 (cation injection q=0.39). As discussed above with reference to FIG. 5, a gas source 550 was operated to deliver a neutral gas to the sub-volume 540 during cation injection. After the group of precursor cations entered Q3, a DC barrier voltage was applied to IQ3 to trap the ions within Q3. After cooling the trapped cations and ejecting the reagent anions from Q3, the residual precursor cations were subjected to mass selective axial ejection to the detector. Comparing the results depicted in FIG. 7(d) to those of FIG. 7(a), it will be appreciated that use of a quadrupole rod set Q3 modified in accord with the teachings herein as an ion-ion reaction region can be effective to generate product ions.

With reference now to FIG. 7(e), the experimental mass spectral data was obtained using a substantially identical method and system to that generally described above in reference to FIG. 7(d). The methods and systems differ, however, in that an RF voltage was not applied to the auxiliary electrodes 520. Rather, only a negative DC potential was applied to the auxiliary electrodes 520. Nonetheless, in comparing the mass spectral data of FIGS. 7(d) and 7(e), it should be appreciated that removal of the RF voltage had a negligible effect.

With reference now to FIG. 7(f), the experimental mass spectral data was obtained using a substantially identical method and system to that generally described above in reference to FIG. 7(e). The methods and systems differ, however, in that the q value for the cation injection was increased from q=0.39 to q=0.54. It should be appreciated that by increasing the q value for cation injection, the resulting mass spectrum demonstrates clearly defined product ion peaks consistent with those of the prior art mutual storage techniques performed in Q2 (i.e., FIG. 7(a)).

Accordingly, unlike prior art systems and methods that utilize the static higher pressure Q2 collision cell to trap ions simultaneously for ion-ion reactions, in various embodiments according the methods and systems described herein, the Q3 quadrupole rod set can be modified to perform high efficiency ion-ion reactions. Though not bound by any particular theory, it is believed that various embodiments of the methods and systems described herein can capture a first ion group in a sub-volume of the quadrupole rod set while ions of the opposite polarity are trapped in a dynamic confinement region which at least partially overlaps with the sub-volume during at least a portion of the trapping of the second group. Unlike mutual storage techniques (which occur at a single energy and rely on lower energy interactions) and pass-through techniques (in which precursor cations traverse the multipole a single time at a single energy level), methods and systems in accord with various embodiments of the teachings herein can enable precursor cations, for example, to make multiple passes through the reagent anions contained within the sub-volume, thereby increasing interaction time and promoting interaction of the ions at different energy levels.

It will be appreciated that the mass spectrometer system 100 described herein is but one possible configuration that can be used according to aspects of the systems, devices, and methods disclosed herein. For example, although the quadrupoles Q0, Q1, Q2, and Q3 have been described as having configurations and modes designed to achieve a particular purpose, a person skilled in the art will recognize that each of the quadrupoles can also have other configurations and be operated in other modes depending at least in part on the desired mass spectrometer application. Further, it will be appreciated that various aspects of the described teachings can be applied to other components of a mass spectrometer system. By way of example, various aspects of the teachings herein can be applied to trap ions of a first polarity in a sub-volume of Q2, for example. Other non-limiting, exemplary embodiments of mass spectrometers that can be used in conjunction with the systems, devices, and methods disclosed herein can be found, for example, in U.S. Pat. No. 7,923,681, entitled “Collision Cell for Mass Spectrometer,” which is hereby incorporated by reference in its entirety. Other configurations, including but not limited to those described herein and others known to those skilled in the art, can also be utilized in conjunction with the systems, devices, and methods disclosed herein.

While the above description provides examples and specific details of various embodiments, it will be appreciated that some features and/or functions of the described embodiments admit to modification without departing from the scope of the described embodiments. The above description is intended to be illustrative of the applicants' teachings, the scope of which is limited only by the language of the claims appended hereto.

1. A method for performing ion-ion reactions in a mass spectrometer system, comprising:
introducing a first group of ions into a multipole ion trap comprising a quadrupole rod set extending from a first end to a second end, the quadrupole rod set having an end electrode located at each end thereof;
applying a DC voltage to at least one auxiliary electrode disposed between the first and second ends of the quadrupole rod set and an RF voltage to one of said end electrodes to confine the first group of ions axially within a sub-volume of the multipole ion trap between the at least one auxiliary electrode and said one of said end electrodes;
introducing a second group of ions into the multipole ion trap, the second group of ions being of opposite polarity to the first group of ions;
allowing the first group of ions to undergo ion-ion reactions with the second group of ions to produce product ions while maintaining the first group of ions within said sub-volume.

2. The method of claim 1, wherein the first group of ions comprises one of reagent anions and the second group of ions comprises precursor cations and wherein the first group of ions comprises precursor cations and the second group of ions comprises reagent anions.

3. The method of claim 2, wherein applying a DC voltage to the at least one auxiliary electrode comprises one of applying a negative DC voltage and applying a positive DC voltage.

4. The method of claim 1, further comprising applying an RF voltage to the quadrupole rod set to confine the first and second groups of ions radially within the multipole ion trap.

5. The method of claim 1, wherein allowing the first group of ions to interact with the second group of ions to produce product ions while maintaining the first group of ions within said sub-volume comprises maintaining the DC voltage on the at least one auxiliary electrode disposed between the first and second ends of the quadrupole rod set and an RF voltage on one of said end electrodes, further comprising, while maintaining the first group of ions within said sub-volume, applying a barrier voltage to the other of said end electrodes to trap the second group of ions within the multipole ion trap.

6. The method of claim 5, wherein the barrier voltage comprises an RF voltage.

7. The method of claim 5, wherein the barrier voltage comprises a DC voltage having the same polarity as the second group of ions.

8. The method of claim 5, wherein the barrier voltage causes said second group of ions to make multiple passes through said sub-volume.

9. The method of claim 1, wherein:
i) the end electrodes comprise a first end electrode located adjacent to the first end of the quadrupole rod set and a second end electrode located adjacent to the second end of the quadrupole rod set; and
ii) the at least one auxiliary electrode comprises a plurality of auxiliary electrodes interposed between the quadrupole rods and extending from a first end to a second end along a length of the quadrupole rod set, the first end of the auxiliary electrodes being located between the first end of the quadrupole rod set and the second end of the auxiliary electrodes, and the second end of the auxiliary electrodes being located between the first end of the auxiliary electrodes and the second end of the quadrupole rod set, wherein applying a DC voltage to the auxiliary electrodes comprises applying a negative DC voltage such that the first group of ions are axially confined between the second end of the auxiliary electrodes and the second end electrode, the first group of ions having a negative polarity.

10. The method of claim 1, wherein the ion-ion reaction comprises one of an electron transfer) dissociation reaction and a proton-transfer reaction.

11. The method of claim 1, wherein the quadrupole rod set comprises Q3 in a triple quadrupole mass spectrometer, wherein the quadrupole rod set is contained within a vacuum chamber such that a base operating pressure is less than about 1×10⁻⁴ Torr, further comprising introducing one or more pulses of a gas into said sub-volume, wherein the pulses of gas are configured to increase the pressure in said sub-volume in a range of about 6×10⁻⁵ Torr to about 5×10⁻⁴ Torr, wherein the second group of ions are introduced into the multipole ion trap with a kinetic energy less than about 10 eV, wherein the auxiliary electrodes comprise T-electrodes, and wherein the T-electrodes have an increasing depth of radial penetration along a length of the quadrupole rod set.

12. A mass spectrometer system, comprising:
one or more ion sources configured to generate a first group of ions and a second group of ions, wherein the first and second groups of ions have opposite polarities;
a multipole ion trap comprising (i) a quadrupole rod set extending from a first end to a second end, (ii) at least one auxiliary electrode disposed between the first and second ends of the quadrupole rod set, and (iii) end electrodes located at both ends of the quadrupole rod set; and
a controller, operatively coupled to the multipole ion trap, the controller configured to i) apply a DC voltage to the at least one auxiliary electrode and an RF voltage to one of said end electrodes to confine the first group of ions axially within a sub-volume of the multipole ion trap between the at least one auxiliary electrode and said one of said end electrodes, and ii) apply a barrier voltage to the other of said end electrodes while maintaining the first group of ions within said sub-volume such that the first and second group of ions are trapped within the multipole ion trap and can interact to produce product ions.

13. The system of claim 12, wherein the barrier voltage comprises an RF voltage.

14. The system of claim 12, wherein the barrier voltage comprises a DC voltage having the same polarity as the second group of ions.

15. The system of claim 12, wherein the controller is configured to apply or adjust voltages to any of the quadrupole rod set, auxiliary electrodes, or end electrodes so as to cause said second group of ions to make multiple passes through said sub-volume, and wherein the controller is further configured to apply an RF voltage to the quadrupole rod set to confine the first and second groups of ions radially within the multipole ion trap.

16. The system of claim 12, wherein the first group of ions comprises reagent anions and the second group of ions comprises precursor cations, and wherein the controller is configured to apply a negative DC voltage to the at least one auxiliary electrode to confine the reagent anions axially within the sub-volume of the multipole ion trap between the at least one auxiliary electrode and said one of said end electrodes.

17. The system of claim 12, wherein the first group of ions comprises precursor cations and the second group of ions comprises reagent anions, and wherein the controller is configured to apply a positive DC voltage to the at least one auxiliary electrode to confine the precursor cations axially within the sub-volume of the multipole ion trap between the at least one auxiliary electrode and said one of said end electrodes.

18. The system of claim 12, wherein:
i) the end electrodes comprise a first end electrode located adjacent to the first end of the quadrupole rod set and a second end electrode located adjacent to the second end of the quadrupole rod set,
ii) the at least one auxiliary electrode comprises a plurality of auxiliary electrodes interposed between the quadrupole rods and extending from a first end to a second end along a length of the quadrupole rod set, the first end of the auxiliary electrodes being located between the first end of the quadrupole rod set and the second end of the auxiliary electrodes, and the second end of the auxiliary electrodes being located between the first end of the auxiliary electrodes and the second end of the quadrupole rod set, and
wherein the controller is configured to apply a negative DC voltage to the auxiliary electrodes such that the first group of ions are axially confined between the second end of the auxiliary electrodes and the second end electrode, the first group of ions having a negative polarity.

19. The system of claim 12, wherein the quadrupole rod set comprises Q3 in a triple quadrupole mass spectrometer, wherein the quadrupole rod set is contained within a vacuum chamber such that a base operating pressure is less than about 1×10⁻⁴ Torr, and further comprising a gas source configured to introduce one or more pulses of a gas into said sub-volume, wherein the pulses of gas are configured to increase the pressure in said sub-volume in a range of about 6×10⁻⁵ Torr to about 5×10⁻⁴ Torr, wherein the auxiliary electrodes comprise T-electrodes, and wherein the T-electrodes have an increasing depth of radial penetration along a length of the quadrupole rod set.

20. A method for performing ion-ion reactions in a mass spectrometer system, comprising:
confining a first group of ions in a sub-volume of a multipole ion trap;
introducing a second group of ions into the multipole ion trap, the first and second groups of ions being of opposite polarity; and
while maintaining the first group of ions within said sub-volume, generating an exit barrier at an exit end of the multipole ion trap to reflect at least a portion of the second group of ions through said sub-volume at least two times.
